(19) United States
(12) Patent Application Publication
(10) Pub. No.: US 2026/0258844 A1
(43) Pub. Date: Sep. 3, 2026

(54) COMPENSATOR ASSEMBLY FOR VEHICLE DRIVE SYSTEM

(71) Applicant: Harley-Davidson Motor Company, Inc., Milwaukee, WI (US)

(72) Inventors: Michal Olechowski, South Milwaukee, WI (US); Timothy S. McChesney, Kewaskum, WI (US); Dean Lax, Brownsville, WI (US); Matthew Eustace, Milwaukee, WI (US); Tyler Harper, Gastonia, NC (US)

(73) Assignee: Harley-Davidson Motor Company, Inc., Milwauke, WI (US)

(21) Appl. No.: 19/066,704

(22) Filed: Feb. 28, 2025

(51) Int. Cl. F16D 7/04

(52) U.S. Cl. CPC F16D 7/044

(57) ABSTRACT

An example compensator assembly for a vehicle drive system, a vehicle drive system, and a vehicle having such a compensator assembly. The compensator assembly is mounted directly to an input shaft of the gearcase to transmit drive torque thereto while isolating the input shaft from tensile loading (e.g., belt, chain, and the like).

### TECHNICAL FIELD

One or more embodiments relate generally to a compensator assembly for a vehicle drive system, a vehicle drive system, and a vehicle having such a compensator assembly. The compensator assembly is mounted directly to an input shaft of the gearcase to transmit drive torque thereto while isolating the input shaft from tensile loading (e.g., belt, chain, and the like).

### BACKGROUND

A compensator assembly is generally arranged between a crankshaft of a vehicle engine and a rear wheel to dampen impulse (torque) loads between the crankshaft and the rear wheel(s). By reducing the impulse (torque) loads, overall wear on the vehicle engine is reduced while also enhancing the performance of the vehicle by providing a smoother transfer of power to the rear wheel(s).

Compensator assemblies for two and three-wheeled vehicles such as motorcycles and tricycles (i.e., trikes) are generally mounted to the wheel or differential directly before power is transferred to the rear wheel. For open differential designs and CV shafts, the compensator assembly are generally mounted to an input side of the system. Typically, the components of the compensator assembly are integrated into the wheel.

### BRIEF SUMMARY

In accordance with one or more embodiments, a compensator assembly for a vehicle drive system is mounted directly to an input side (e.g., input shaft) of the differential gearcase.

In accordance with one or more embodiments, a vehicle includes a drive system having a differential gearcase housing one or more gears and an input shaft that is operable to receive drive torque from the vehicle engine. The differential gearcase comprises a housing or shell that defines a bearing mounting region upon which the bearing is mounted to facilitate transfer of tensile loading (e.g., belt, chain, and the like) directly to the differential gearcase.

A compensator assembly is rotatably coupled to the input shaft to facilitate transmission of the drive torque from the vehicle engine to the input shaft. The compensator assembly includes a bearing that is directly supported on the differential gearcase. The bearing is retained on the differential gearcase by a bearing adapter.

A sprocket is providing and formed having a plurality of sprocket teeth operable to engage a drive belt of the vehicle engine. The sprocket is to transmit the drive torque supplied by the drive device (e.g., drive belt, drive chain, and the like) to the input shaft. The bearing adapter including the bearing is coupled to the sprocket via one or more fasteners. The sprocket further includes a cylindrical-shaped hub member defining a central bore through which the input shaft extends in an assembled state of the compensator assembly on the differential gearcase.

The drive torque supplied by the vehicle engine, by way of an engagement between the sprocket and a rotatable isolator member, is transmitted through the isolator member into a rotatable compensator bowl. Due to the coupling of the input shaft and the compensator bowl, the drive torque is transmitted to the input shaft.

By directly mounting the compensator assembly to the input shaft, the input shaft is isolated from tensile loading during operation of the vehicle. For instance, by mounting the bearing directly on the differential gearcase, tensile loading transmitted to the sprocket is transferred to the bearing, which in turn transfers the tensile loading directly to the differential gearcase. The compensator assembly is thereby operable to transmit the drive torque from the sprocket to the input shaft via the isolator member and the compensator bowl. In that way, the input shaft is isolated from tensile loading.

In accordance with one or more embodiments, an example vehicle drive system comprises one or more of the following: a differential gearcase; a rotatable input shaft arranged in the differential gearcase; and a compensator assembly rotatably coupled to the input shaft, the compensator assembly including a sprocket operable to receive drive torque and drive load from a drive device (e.g., drive belt, drive chain, and the like), a bearing mounted on the differential gearcase to transmit the drive load from the sprocket to the differential gearcase, a rotatable isolator member to receive the drive torque from the sprocket, and a rotatable compensator bowl operably coupled to the isolator member and the input shaft to transmit the drive torque from the isolator member to the input shaft.

In accordance with one or more embodiments, an example vehicle comprises one or more of the following: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive load from a drive device (e.g., drive belt, drive chain, and the like) , a bearing mounted on the differential gearcase to transmit the drive load from the sprocket to the differential gearcase, a rotatable isolator member to receive the drive torque from the sprocket, and a rotatable compensator bowl operably coupled to the isolator member and the input shaft to transmit the drive torque from the isolator member to the input shaft.

In accordance with one or more embodiments, an example compensator assembly for a vehicle drive system comprises one or more of the following: a sprocket operable to receive drive torque and tensile drive loading from a drive device (e.g., drive belt, drive chain, and the like); a bearing mounted on a differential gearcase to transmit the drive load from the sprocket to the differential gearcase; a rotatable isolator member to receive the drive torque from the sprocket; and a rotatable compensator bowl operably coupled to the isolator member and the input shaft to transmit the drive torque from the isolator member to the input shaft.

In accordance with one or more embodiments, an example vehicle drive system comprises one or more of the following: a differential gearcase; a rotatable input shaft arranged in the differential gearcase; and a compensator assembly rotatably coupled to the input shaft, the compensator assembly including a sprocket operable to receive drive torque and drive load from a vehicle engine, a bearing mounted on the differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

In accordance with one or more embodiments, an example vehicle comprises one or more of the following: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive load from a vehicle engine, a bearing mounted on a differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

In accordance with one or more embodiments, an example compensator assembly for a vehicle drive system comprises one or more of the following: a sprocket operable to receive drive torque and tensile drive loading from a vehicle engine; a bearing mounted on a differential gearcase to transmit the drive load from the sprocket to the differential gearcase; a rotatable isolator member to receive the drive torque from the sprocket; and a rotatable compensator bowl operably coupled to the rotatable isolator member and an input shaft to transmit the drive torque from the rotatable isolator member to the input shaft.

In accordance with one or more embodiments, an example vehicle drive system comprises one or more of the following: a differential gearcase; a rotatable input shaft arranged in the differential gearcase; and a compensator assembly rotatably coupled to the input shaft, the compensator assembly including a sprocket operable to receive drive torque and drive load from a drive source, a bearing mounted on the differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

In accordance with one or more embodiments, an example vehicle comprises one or more of the following: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive load from a drive source, a bearing mounted on a differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

In accordance with one or more embodiments, an example compensator assembly for a vehicle drive system comprises one or more of the following: a sprocket operable to receive drive torque and tensile drive loading from a drive source; a bearing mounted on a differential gearcase to transmit the drive load from the sprocket to the differential gearcase; a rotatable isolator member to receive the drive torque from the sprocket; and a rotatable compensator bowl operably coupled to the rotatable isolator member and an input shaft to transmit the drive torque from the rotatable isolator member to the input shaft.

In accordance with one or more embodiments, a bearing adapter member is provided and includes a central bore operable to concentrically receive and retain the bearing on the differential gearcase, the bearing adapter member further having a plurality of openings to facilitate coupling of the bearing adapter member to the sprocket.

In accordance with one or more embodiments, the sprocket comprises a sprocket hub member defining a central bore through which the input shaft extends in an assembled state of the compensator assembly.

In accordance with one or more embodiments, the sprocket comprises a plurality of lug members extending radially outward from the sprocket hub member.

In accordance with one or more embodiments, the isolator member comprises a plurality of first isolation members spaced apart from each other to extend radially outward from an isolator hub member to engage the plurality of lug members to facilitate transfer of the drive torque from the sprocket to the isolator member.

In accordance with one or more embodiments, the isolator member comprises a plurality of second isolation members spaced apart from each other to extend radially outward from the isolation hub member.

In accordance with one or more embodiments, the compensator bowl comprises an annular housing surface that defines a chamber that opens toward the differential gearcase.

In accordance with one or more embodiments, the compensator bowl comprises a compensator bowl hub member projecting from the annular housing surface for coupling to the input shaft.

In accordance with one or more embodiments, the compensator bowl comprises a plurality of radial projections extending from the annular housing surface to define the plurality of recesses.

In accordance with one or more embodiments, the plurality of second isolation members are positioned in the plurality of recesses to engage the compensator bowl in a manner that facilitates transmission of the drive torque from the isolator member to the compensator bowl.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 illustrates a side view of an example vehicle, in accordance with one or more embodiments set forth, illustrated, and described herein.

FIG. 2 illustrates an exploded view of an example compensator assembly of the example vehicle of FIG. 1.

FIG. 3 illustrates a perspective view of a bearing adapter of the example compensator assembly.

FIG. 4 illustrates a perspective view of a bearing of the example compensator assembly.

FIG. 5 illustrates a front view of the example compensator assembly in an assembled state.

FIG. 6 illustrates a cross-sectional view of the example compensator assembly taken along line 5-5 of FIG. 4.

FIGS. 7A and 7B respectively illustrate a perspective view and a front view of a compensator bowl of the example compensator assembly.

FIG. 8 illustrates a perspective view of a vehicle drive system, in accordance with one or more embodiments set forth, illustrated, and described herein.

### DETAILED DESCRIPTION

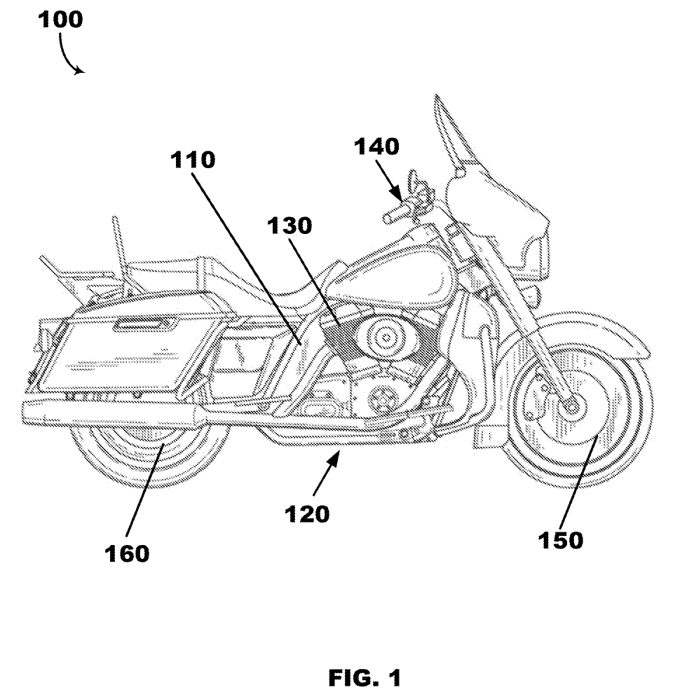

Turning to the figures, in which FIG. 1 illustrates an example vehicle 100 having a vehicle structure 110 (e.g., chassis, frame, subframe, body, front/rear forks, etc.), a drive system 120 mounted on the vehicle structure 110, a vehicle engine 130 mounted on the vehicle structure 110 to provide power and torque to the drive system 120, a steering assembly 140 pivotably mounted to the vehicle structure 110, a front wheel 150 rotatably mounted to the steering assembly 140, and one or more rear wheels 160 to be driven by the drive system 120.

In accordance with one or more embodiments, a “vehicle” may be in reference to any form of motorized transport. In the illustrated embodiment of FIG. 1, the vehicle 100 comprises a two-wheeled vehicle such as a motorcycle. Embodiments, however, are not limited thereto, and thus, this disclosure contemplates the vehicle comprising a three-wheeled vehicle, a four-wheeled vehicle, or any suitable vehicle that falls within the spirit and scope of the principles of this disclosure. This disclosure contemplates the vehicle engine 130 comprising an internal combustion engine, an electric engine, a hybrid engine, or any suitable engine that falls within the spirit and scope of the principles of this disclosure.

In accordance with one or more embodiments, the vehicle 100 may comprise one or more operational elements. Some of the possible operational elements of the vehicle 100 are shown in FIG. 1 and will now be described. It will be understood that it is not necessary for the vehicle 100 to have all the elements illustrated in FIG. 1 and/or described herein. The vehicle 100 may have any combination of the various elements illustrated in FIG. 1. Moreover, the vehicle 100 may have additional elements to those illustrated in FIG. 1, or may not include one or more of the elements shown in FIG. 1. Moreover, while the various operational elements are illustrated as being located within the vehicle 100, embodiments are not limited thereto, and thus, one or more of the operational elements may be located external to the vehicle 100, and even physically separated by large spatial distances.

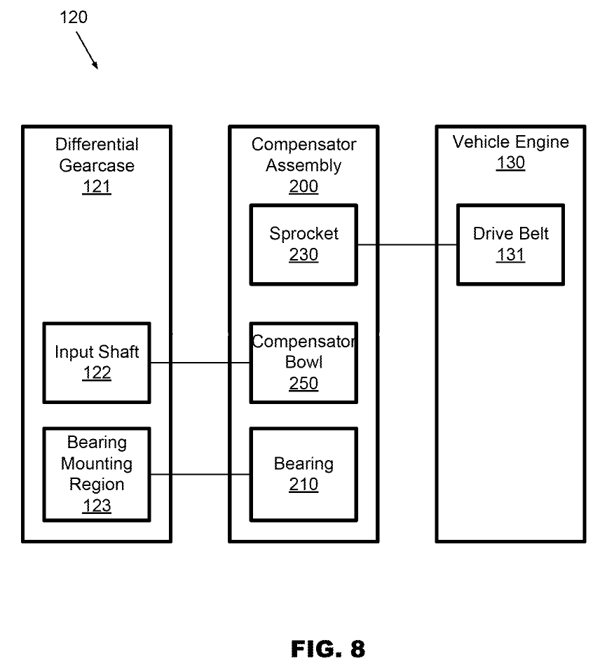

As illustrated in FIG. 8, the drive system 120 includes a differential gearcase 121 and an input shaft 122 to receive the power output from the vehicle engine 130. The differential gearcase 121 comprises a housing or shell that defines a bearing mounting region 123.

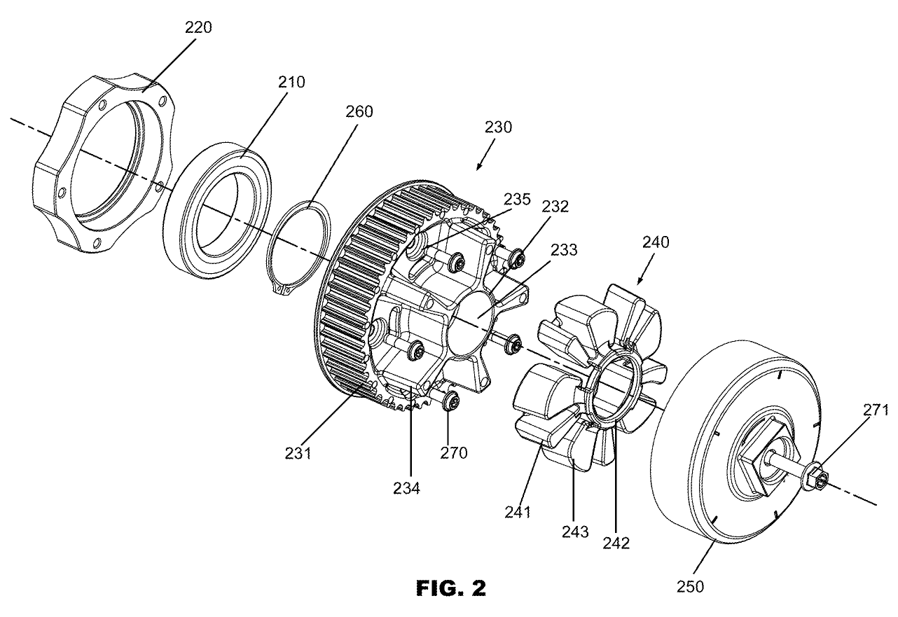

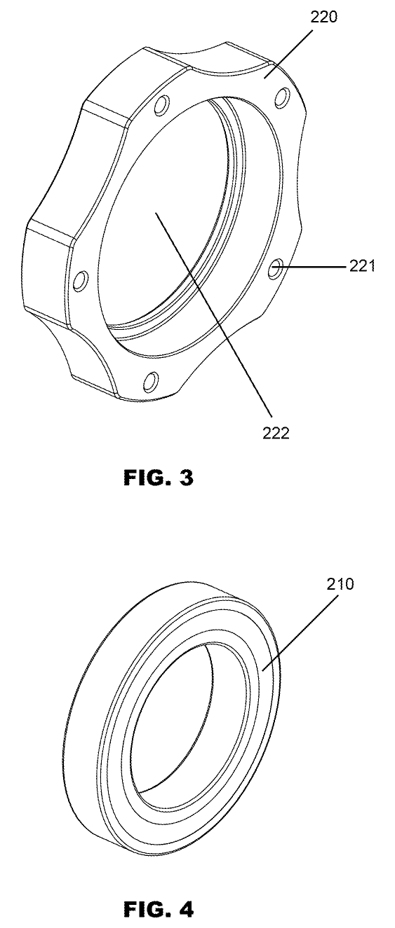

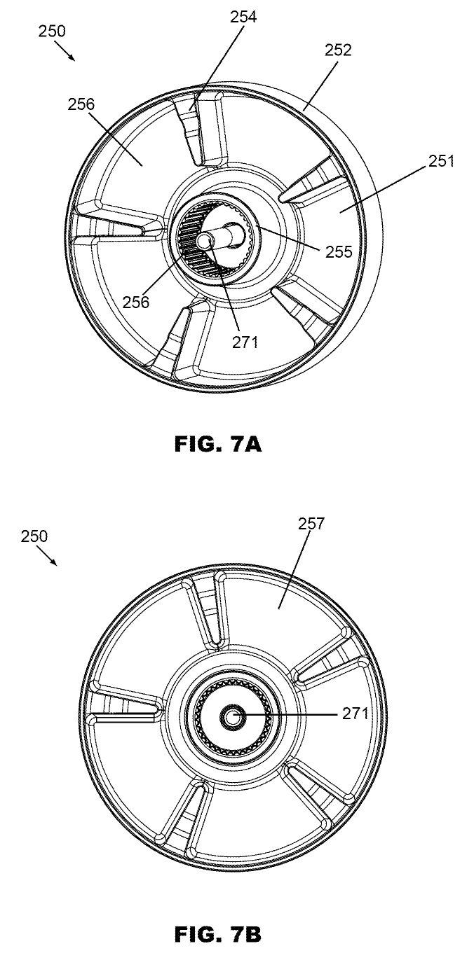

The drive system 120 also includes a compensator assembly 200 rotatably coupled to the input shaft 122 to dampen the impulse loads between the vehicle engine 130 and the one or more rear wheels 160 while also facilitating transmission of drive torque from the vehicle engine 130 to the input shaft 122. The compensator assembly 200 includes a bearing 210 (FIG. 4), a bearing adapter 220 (FIG. 3), a sprocket 230 (FIG. 2),, an isolator member 240 (FIG. 2), and a compensator bowl 250 (FIGS. 7A and 7B).

The bearing 210 is supported on a bearing mounting region 123 of the differential gearcase 121. The bearing 210 is retained on the differential gearcase 121 by a bearing adapter 220. The bearing adapter 220 has a generally circular body having an inner diameter that defines a central bore 222 that concentrically receives (e.g., by a diametric interference fit) and retains the bearing 210 in its mounted position on the bearing mounting region 123. A retaining ring 260 (FIG. 2) is provided to maintain the compensator assembly 200 on the input shaft 122.

As illustrated in FIG. 2, the sprocket 230 has a plurality of sprocket teeth 231 operable to engage a drive belt 131 of the vehicle engine 130. The sprocket 230 is to transmit the drive torque supplied by the drive belt 131 to the input shaft 122. Although the illustrated embodiment of FIG. 2 illustrates a drive belt 131, embodiments are not limited thereto. This disclosure contemplates the vehicle engine 130 having a drive chain or any suitable drive device that falls within the spirit and scope of the principles of this disclosure. The coupled arrangement of the bearing 210 and the bearing adapter 220 is coupled to an inner face of the sprocket 230 that faces the differential gearcase 121. Such coupling between the bearing adapter 220 and the sprocket 230 is accomplished using one or more fasteners 270 that extend through sprocket openings 235 and bearing adapter opening 221. The sprocket 230 further includes a cylindrical-shaped hub member 232 defining a central bore 233 through which the input shaft 122 extends in an assembled state of the compensator assembly 200 on the differential gearcase 121. A plurality of lug members 234 are spaced apart from each other to extend radially outward from the hub member 232 and the outer face of the sprocket 230 that faces the compensator bowl 250. By way of an engagement between the sprocket 230 and an isolator member 240, drive torque from the drive belt is transmitted through the isolator member 240 into a compensator bowl 250. Due to the coupling (via a fastener 271) between the input shaft 122 and the compensator bowl 250, the drive torque is transmitted to the input shaft 122.

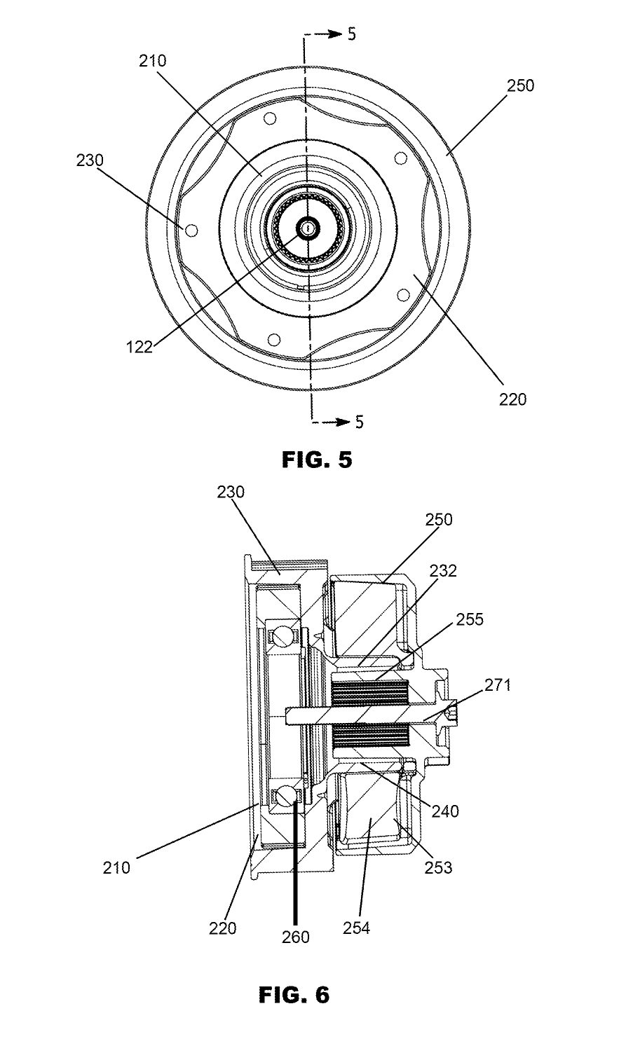

The isolator member 240 has a plurality of first isolation members 241 spaced apart from each other to extend radially outward from a hub member 242. The hub member 242, in an assembled state of the compensator assembly 200, extends through the central bore 233 defined by the hub member 232 (FIG. 6). The plurality of first isolation members 241 are formed having a shape or cross-section that corresponds to the shape or cross-section of the plurality of lug members 234 of the sprocket 230. The plurality of first isolation members 241 engage and/or are coupled to the plurality of lug members 234 to facilitate transfer of the drive torque from the sprocket 230 to the isolator member 240. The isolator member 240 further has a plurality of second isolation members 243 spaced apart from each other to extend radially outward from the hub member 242. Each second isolation member 243 is positioned between adjacent first isolation members 241. The plurality of second isolation members 243 are formed having a shape or cross-section that corresponds to the shape or cross-section of plurality of recesses 256 (FIG. 5) formed by plurality of radial projections 254 of an annular housing surface 251 of the compensator bowl 250. In an assembled state and/or an operating state of the compensator assembly 200, the plurality of second isolation members 243 are positioned in the plurality of recesses 256 to engage the compensator bowl 250 in a manner that facilitates transmission of the drive torque from the isolator member 240 to the compensator bowl 250.

FIGS. 5 and 6 illustrate the assembled state and/or an operating state of the bearing 210, the bearing adapter 220, the sprocket 230, the isolator member 240, and the compensator bowl 250 to form the example compensator assembly.

As illustrated in FIG. 7A, the compensator bowl 250 defines an annular housing surface 251 that faces the differential gearcase 121. The compensator bowl 250 includes a generally cylindrical wall 252 that cooperates with the housing surface 251 to define a chamber 253 that opens toward the differential gearcase 121. A plurality of radial projections 254 are spaced apart from each other to extend from the annular housing surface 251 to define the plurality of recesses 256 that position the isolator member 240 in the chamber 253. A hub member 255 projects from the annular housing surface 251 towards the differential gearcase 121 to receive the input shaft 122. The hub member 255 has a plurality of teeth 256 that are operable to mate with teeth from the input shaft 122.

As illustrated in FIG. 7B, the compensator bowl 250 further defines an outer housing surface 257 that faces away from the differential gearcase 121. The outer housing surface 257 has an opening. The fastener 271 extends through the opening and into the chamber 253 to facilitate the coupling between the input shaft 122 and the compensator bowl 250.

During operation of the vehicle 100, the drive belt 131 transmit a drive torque from the vehicle engine 130 to the sprocket 230 by engagement with the plurality of sprocket teeth 231. The drive torque is transmitted by the sprocket 230 to the isolator member 240, which in turn, is transferred to the compensator bowl 250 due to the engagement and/or coupling between the plurality of first isolation members 241 of the isolator member 240 and the plurality of lug members 234 of the sprocket 230. The compensator bowl 250 then transmits the drive torque to cause rotation of the input shaft 122. At the inner face of the sprocket 230, tensile belt loads are transmitted by the sprocket 230 to the bearing 210. In that way, the input shaft 122 is isolated from tensile loading (e.g., belt, chain, and the like), thereby enhancing the performance of the drive system 120. Thus, the sprocket 230 has a structural configuration that includes an outer face that causes transmission of the drive torque to the input shaft 122 and an inner face that causes transmission of tensile loading (e.g., belt, chain, and the like) to the differential gearcase 121 to advantageously isolate the input shaft 122 from the tensile belt loads.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments of the present disclosure may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

The disclosure further includes additional notes and examples, as set forth in the following clauses.

Clause 1A. A vehicle drive system, comprising: a differential gearcase; a rotatable input shaft arranged in the differential gearcase; and a compensator assembly rotatably coupled to the input shaft, the compensator assembly including a sprocket operable to receive drive torque and drive belt load from a drive belt, a bearing mounted on the differential gearcase to transmit the drive belt load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 2A. The vehicle drive system of Clause 1A, further comprising a bearing adapter member having a central bore operable to concentrically receive and retain the bearing on the differential gearcase, the bearing adapter member further having a plurality of openings to facilitate coupling of the bearing adapter member to the sprocket.

Clause 3A. The vehicle drive system of Clause 1A, wherein the sprocket comprises: a sprocket hub member defining a central bore through which the input shaft extends in an assembled state of the compensator assembly, and a plurality of lug members extending radially outward from the sprocket hub member.

Clause 4A. The vehicle drive system of Clause 3A, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause 5A. The vehicle drive system of Clause 4A, wherein the rotatable isolator member comprises a plurality of second isolation members spaced apart from each other to extend radially outward from the isolation hub member.

Clause 6A. The vehicle drive system of Clause 5A, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 7A. The vehicle drive system of Clause 6A, wherein the plurality of second isolation members are positioned in the plurality of recesses to engage the compensator bowl in a manner that facilitates transmission of the drive torque from the rotatable isolator member to the compensator bowl.

Clause 8A. A vehicle, comprising: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive belt load from a drive belt, a bearing mounted on a differential gearcase to transmit the drive belt load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 9A. The vehicle of claim 8A, further comprising a bearing adapter member having a central bore operable to concentrically receive and retain the bearing on the differential gearcase, the bearing adapter member further having a plurality of openings to facilitate coupling of the bearing adapter member to the sprocket.

Clause 10A. The vehicle of Clause 8A, wherein the sprocket comprises: a sprocket hub member defining a central bore through which the input shaft extends in an assembled state of the compensator assembly, and a plurality of lug members extending radially outward from the sprocket hub member.

Clause 11A. The vehicle of Clause 10A, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause12A. The vehicle of Clause 11A, wherein the rotatable isolator member comprises a plurality of second isolation members spaced apart from each other to extend radially outward from the isolation hub member.

Clause 13A. The vehicle of Clause 12A, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 14A. The vehicle of Clause 13A, wherein the plurality of second isolation members are positioned in the plurality of recesses to engage the compensator bowl in a manner that facilitates transmission of the drive torque from the rotatable isolator member to the compensator bowl.

Clause 15A. A compensator assembly for a vehicle drive system, the compensator assembly comprising: a sprocket operable to receive drive torque and tensile drive belt loading from a drive belt; a bearing mounted on a differential gearcase to transmit the drive belt load from the sprocket to the differential gearcase; a rotatable isolator member to receive the drive torque from the sprocket; and a rotatable compensator bowl operably coupled to the rotatable isolator member and an input shaft to transmit the drive torque from the rotatable isolator member to the input shaft.

Clause 16A. The compensator assembly of Clause 15A, further comprising a bearing adapter member having a central bore operable to concentrically receive and retain the bearing on the differential gearcase, the bearing adapter member further having a plurality of openings to facilitate coupling of the bearing adapter member to the sprocket.

Clause 17A. The compensator assembly of Clause 15A, wherein the sprocket comprises: a sprocket hub member defining a central bore through which the input shaft extends in an assembled state of the compensator assembly, and a plurality of lug members extending radially outward from the sprocket hub member.

Clause 18A. The compensator assembly of Clause 17A, wherein the rotatable isolator member comprises: a plurality of first isolation members spaced apart from each other to extend radially outward from an isolator hub member to engage the plurality of lug members to facilitate transfer of the drive torque from the sprocket to the rotatable isolator member, and a plurality of second isolation members spaced apart from each other to extend radially outward from the isolation hub member.

Clause 19A. The compensator assembly of Clause 18A, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 20A. The compensator assembly of Clause 19A, wherein the plurality of second isolation members are positioned in the plurality of recesses to engage the compensator bowl in a manner that facilitates transmission of the drive torque from the rotatable isolator member to the compensator bowl.

Clause 1B. A vehicle drive system, comprising: a differential gearcase; a rotatable input shaft arranged in the differential gearcase; and a compensator assembly rotatably coupled to the input shaft, the compensator assembly including a sprocket operable to receive drive torque and drive load from a vehicle engine, a bearing mounted on the differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 2B. The vehicle drive system of Clause 1B, further comprising a bearing adapter member having a central bore operable to concentrically receive and retain the bearing on the differential gearcase, the bearing adapter member further having a plurality of openings to facilitate coupling of the bearing adapter member to the sprocket.

Clause 3B. The vehicle drive system of Clause 1B, wherein the sprocket comprises: a sprocket hub member defining a central bore through which the input shaft extends in an assembled state of the compensator assembly, and a plurality of lug members extending radially outward from the sprocket hub member.

Clause 4B. The vehicle drive system of Clause 3B, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause 5B. The vehicle drive system of Clause 4B, wherein the rotatable isolator member comprises a plurality of second isolation members spaced apart from each other to extend radially outward from the isolation hub member.

Clause 6B. The vehicle drive system of Clause 5B, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 7B. The vehicle drive system of Clause 6B, wherein the plurality of second isolation members are positioned in the plurality of recesses to engage the compensator bowl in a manner that facilitates transmission of the drive torque from the rotatable isolator member to the compensator bowl.

Clause 8B. A vehicle, comprising: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive load from a vehicle engine, a bearing mounted on a differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 9B. The vehicle of claim 8B, further comprising a bearing adapter member having a central bore operable to concentrically receive and retain the bearing on the differential gearcase, the bearing adapter member further having a plurality of openings to facilitate coupling of the bearing adapter member to the sprocket.

Clause 10B. The vehicle of Clause 8B, wherein the sprocket comprises: a sprocket hub member defining a central bore through which the input shaft extends in an assembled state of the compensator assembly, and a plurality of lug members extending radially outward from the sprocket hub member.

Clause 11B. The vehicle of Clause 10B, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause 12B. The vehicle of Clause 11B, wherein the rotatable isolator member comprises a plurality of second isolation members spaced apart from each other to extend radially outward from the isolation hub member.

Clause 13B. The vehicle of Clause 12B, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 14B. The vehicle of Clause 13B, wherein the plurality of second isolation members are positioned in the plurality of recesses to engage the compensator bowl in a manner that facilitates transmission of the drive torque from the rotatable isolator member to the compensator bowl.

Clause 15B. A compensator assembly for a vehicle drive system, the compensator assembly comprising: a sprocket operable to receive drive torque and tensile drive loading from a vehicle engine; a bearing mounted on a differential gearcase to transmit the drive load from the sprocket to the differential gearcase; a rotatable isolator member to receive the drive torque from the sprocket; and a rotatable compensator bowl operably coupled to the rotatable isolator member and an input shaft to transmit the drive torque from the rotatable isolator member to the input shaft.

Clause 16B. The compensator assembly of Clause 15B, further comprising a bearing adapter member having a central bore operable to concentrically receive and retain the bearing on the differential gearcase, the bearing adapter member further having a plurality of openings to facilitate coupling of the bearing adapter member to the sprocket.

Clause 17B. The compensator assembly of Clause 15B, wherein the sprocket comprises: a sprocket hub member defining a central bore through which the input shaft extends in an assembled state of the compensator assembly, and a plurality of lug members extending radially outward from the sprocket hub member.

Clause 18B. The compensator assembly of Clause 17B, wherein the rotatable isolator member comprises: a plurality of first isolation members spaced apart from each other to extend radially outward from an isolator hub member to engage the plurality of lug members to facilitate transfer of the drive torque from the sprocket to the rotatable isolator member, and a plurality of second isolation members spaced apart from each other to extend radially outward from the isolation hub member.

Clause 19B. The compensator assembly of Clause 18B, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 20B. The compensator assembly of Clause 19B, wherein the plurality of second isolation members are positioned in the plurality of recesses to engage the compensator bowl in a manner that facilitates transmission of the drive torque from the rotatable isolator member to the compensator bowl.

Clause 1C. A vehicle drive system, comprising: a differential gearcase; a rotatable input shaft arranged in the differential gearcase; and a compensator assembly rotatably coupled to the input shaft, the compensator assembly including a sprocket operable to receive drive torque and drive load from a drive source, a bearing mounted on the differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 2C. The vehicle drive system of Clause 1C, further comprising a bearing adapter member having a central bore operable to concentrically receive and retain the bearing on the differential gearcase, the bearing adapter member further having a plurality of openings to facilitate coupling of the bearing adapter member to the sprocket.

Clause 3C. The vehicle drive system of Clause 1C, wherein the sprocket comprises: a sprocket hub member defining a central bore through which the input shaft extends in an assembled state of the compensator assembly, and a plurality of lug members extending radially outward from the sprocket hub member.

Clause 4C. The vehicle drive system of Clause 3C, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause 5C. The vehicle drive system of Clause 4C, wherein the rotatable isolator member comprises a plurality of second isolation members spaced apart from each other to extend radially outward from the isolation hub member.

Clause 6C. The vehicle drive system of Clause 5C, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 7C. The vehicle drive system of Clause 6C, wherein the plurality of second isolation members are positioned in the plurality of recesses to engage the compensator bowl in a manner that facilitates transmission of the drive torque from the rotatable isolator member to the compensator bowl.

Clause 8C. A vehicle, comprising: a vehicle structure; and a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive load from a drive source, a bearing mounted on a differential gearcase to transmit the drive load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

Clause 9C. The vehicle of claim 8C, further comprising a bearing adapter member having a central bore operable to concentrically receive and retain the bearing on the differential gearcase, the bearing adapter member further having a plurality of openings to facilitate coupling of the bearing adapter member to the sprocket.

Clause 10C. The vehicle of Clause 8C, wherein the sprocket comprises: a sprocket hub member defining a central bore through which the input shaft extends in an assembled state of the compensator assembly, and a plurality of lug members extending radially outward from the sprocket hub member.

Clause 11C. The vehicle of Clause 10C, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

Clause 12C. The vehicle of Clause 11C, wherein the rotatable isolator member comprises a plurality of second isolation members spaced apart from each other to extend radially outward from the isolation hub member.

Clause 13C. The vehicle of Clause 12C, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 14C. The vehicle of Clause 13C, wherein the plurality of second isolation members are positioned in the plurality of recesses to engage the compensator bowl in a manner that facilitates transmission of the drive torque from the rotatable isolator member to the compensator bowl.

Clause 15C. A compensator assembly for a vehicle drive system, the compensator assembly comprising: a sprocket operable to receive drive torque and tensile drive loading from a drive source; a bearing mounted on a differential gearcase to transmit the drive load from the sprocket to the differential gearcase; a rotatable isolator member to receive the drive torque from the sprocket; and a rotatable compensator bowl operably coupled to the rotatable isolator member and an input shaft to transmit the drive torque from the rotatable isolator member to the input shaft.

Clause 16C. The compensator assembly of Clause 15C, further comprising a bearing adapter member having a central bore operable to concentrically receive and retain the bearing on the differential gearcase, the bearing adapter member further having a plurality of openings to facilitate coupling of the bearing adapter member to the sprocket.

Clause 17C. The compensator assembly of Clause 15C, wherein the sprocket comprises: a sprocket hub member defining a central bore through which the input shaft extends in an assembled state of the compensator assembly, and a plurality of lug members extending radially outward from the sprocket hub member.

Clause 18C. The compensator assembly of Clause 17C, wherein the rotatable isolator member comprises: a plurality of first isolation members spaced apart from each other to extend radially outward from an isolator hub member to engage the plurality of lug members to facilitate transfer of the drive torque from the sprocket to the rotatable isolator member, and a plurality of second isolation members spaced apart from each other to extend radially outward from the isolation hub member.

Clause 19C. The compensator assembly of Clause 18C, wherein the compensator bowl comprises: an annular housing surface that defines a chamber that opens toward the differential gearcase, a compensator bowl hub member projecting from the annular housing surface for coupling to the input shaft, and a plurality of radial projections extending from the annular housing surface to define the plurality of recesses.

Clause 20C. The compensator assembly of Clause 19C, wherein the plurality of second isolation members are positioned in the plurality of recesses to engage the compensator bowl in a manner that facilitates transmission of the drive torque from the rotatable isolator member to the compensator bowl.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments of the present disclosure may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A vehicle drive system, comprising:
a differential gearcase;
a rotatable input shaft arranged in the differential gearcase; and
a compensator assembly rotatably coupled to the input shaft, the compensator assembly including a sprocket operable to receive drive torque and drive belt load from a drive belt, a bearing mounted on the differential gearcase to transmit the drive belt load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

2. The vehicle drive system of claim 1, further comprising a bearing adapter member having a central bore operable to concentrically receive and retain the bearing on the differential gearcase, the bearing adapter member further having a plurality of openings to facilitate coupling of the bearing adapter member to the sprocket.

3. The vehicle drive system of claim 1, wherein the sprocket comprises:
a sprocket hub member defining a central bore through which the input shaft extends in an assembled state of the compensator assembly, and
a plurality of lug members extending radially outward from the sprocket hub member.

4. The vehicle drive system of claim 3, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

5. The vehicle drive system of claim 4, wherein the rotatable isolator member comprises a plurality of second isolation members spaced apart from each other to extend radially outward from the isolation hub member.

6. The vehicle drive system of claim 5, wherein the compensator bowl comprises:
an annular housing surface that defines a chamber that opens toward the differential gearcase,
a compensator bowl hub member projecting from the annular housing surface for coupling to the input shaft, and
a plurality of radial projections extending from the annular housing surface to define the plurality of recesses.

7. The vehicle drive system of claim 6, wherein the plurality of second isolation members are positioned in the plurality of recesses to engage the compensator bowl in a manner that facilitates transmission of the drive torque from the rotatable isolator member to the compensator bowl.

8. A vehicle, comprising:
a vehicle structure; and
a vehicle drive system coupled to the vehicle structure, the vehicle drive system including a gearcase, a rotatable input shaft arranged in the gearcase, and a compensator assembly rotatably coupled to the input shaft, the compensator assembly including a sprocket operable to receive drive torque and drive belt load from a drive belt, a bearing mounted on a differential gearcase to transmit the drive belt load from the sprocket to the differential gearcase, a rotatable isolator member to receive the drive torque from the sprocket, and a rotatable compensator bowl operably coupled to the rotatable isolator member and the input shaft to transmit the drive torque from the rotatable isolator member to the input shaft.

9. The vehicle of claim 8, further comprising a bearing adapter member having a central bore operable to concentrically receive and retain the bearing on the differential gearcase, the bearing adapter member further having a plurality of openings to facilitate coupling of the bearing adapter member to the sprocket.

10. The vehicle of claim 8, wherein the sprocket comprises:
a sprocket hub member defining a central bore through which the input shaft extends in an assembled state of the compensator assembly, and
a plurality of lug members extending radially outward from the sprocket hub member.

11. The vehicle of claim 10, wherein the rotatable isolator member comprises a plurality of first isolation members spaced apart from each other to extend radially outward from an isolator hub member to engage the plurality of lug members to facilitate transfer of the drive torque from the sprocket to the rotatable isolator member.

12. The vehicle of claim 11, wherein the rotatable isolator member comprises a plurality of second isolation members spaced apart from each other to extend radially outward from the isolation hub member.

13. The vehicle of claim 12, wherein the compensator bowl comprises:
an annular housing surface that defines a chamber that opens toward the differential gearcase,
a compensator bowl hub member projecting from the annular housing surface for coupling to the input shaft, and
a plurality of radial projections extending from the annular housing surface to define the plurality of recesses.

14. The vehicle of claim 13, wherein the plurality of second isolation members are positioned in the plurality of recesses to engage the compensator bowl in a manner that facilitates transmission of the drive torque from the rotatable isolator member to the compensator bowl.

15. A compensator assembly for a vehicle drive system, the compensator assembly comprising:
a sprocket operable to receive drive torque and tensile drive belt loading from a drive belt;
a bearing mounted on a differential gearcase to transmit the drive belt load from the sprocket to the differential gearcase;
a rotatable isolator member to receive the drive torque from the sprocket; and
a rotatable compensator bowl operably coupled to the rotatable isolator member and an input shaft to transmit the drive torque from the rotatable isolator member to the input shaft.

16. The compensator assembly of claim 15, further comprising a bearing adapter member having a central bore operable to concentrically receive and retain the bearing on the differential gearcase, the bearing adapter member further having a plurality of openings to facilitate coupling of the bearing adapter member to the sprocket.

17. The compensator assembly of claim 15, wherein the sprocket comprises:
a sprocket hub member defining a central bore through which the input shaft extends in an assembled state of the compensator assembly, and
a plurality of lug members extending radially outward from the sprocket hub member.

18. The compensator assembly of claim 17, wherein the rotatable isolator member comprises:
a plurality of first isolation members spaced apart from each other to extend radially outward from an isolator hub member to engage the plurality of lug members to facilitate transfer of the drive torque from the sprocket to the rotatable isolator member, and
a plurality of second isolation members spaced apart from each other to extend radially outward from the isolation hub member.

19. The compensator assembly of claim 18, wherein the compensator bowl comprises:
an annular housing surface that defines a chamber that opens toward the differential gearcase,
a compensator bowl hub member projecting from the annular housing surface for coupling to the input shaft, and
a plurality of radial projections extending from the annular housing surface to define the plurality of recesses.

20. The compensator assembly of claim 19, wherein the plurality of second isolation members are positioned in the plurality of recesses to engage the compensator bowl in a manner that facilitates transmission of the drive torque from the rotatable isolator member to the compensator bowl.
